(19) United States
(12) Patent Application Publication
(10) Pub. No.: US 2007/0286405 A1
(43) Pub. Date: Dec. 13, 2007

(54) VoIP adapter for network interface device

(76) Inventors: Kathleen E. Blake, Keller, TX (US); Jason J. Brown, Bedford, TX (US); Richard A. Kurita, Denton, TX (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/439,086

(22) Filed: May 23, 2006

(51) Int. Cl. H04M 1/00; H04M 9/00

(52) U.S. Cl. 379/413.02

(57) ABSTRACT

An apparatus and methodology for permitting subscriber installation of voice over internet protocol (VoIP) service at a subscriber premises. A VoIP adapter is provided that is configured for snap-in mounting in a subscriber premises network interface device (NID). The adapter includes an input plug connector and an output jack connector, as well as VoIP electronics, and is configured such that the VoIP electronics may be easily coupled in the subscriber incoming service line. Methods for subscriber installation of the adapter are also disclosed.

### FIELD OF THE INVENTION

The present invention relates generally to a VoIP adapter for use at a subscriber premises. More particularly, the present invention relates to a VoIP adapter that is configured to be provided to a subscriber for installation into a network interface device (NID) at a subscriber premises.

### BACKGROUND OF THE INVENTION

As telephone companies migrate to higher bandwidth services including data and video offerings, the desire to transform the analog Plain Old Telephone Service (POTS) network to a Voice over Internet Protocol (VoIP) network increases. VoIP is a term that has become well recognized recently and relates to methodologies for converting analog audio signals into digital data that may be transmitted over the Internet or other digital data transmission networks including, for example, enterprise intranet networks.

POTS has been in use for some time and, because of its relatively low operating frequencies, operates very compatibly with more recently introduced, concurrently provided, Asymmetric Digital Subscriber Line (ADSL) service. More recently, however, Digital Subscriber Line (DSL) service has been proposed to be provided exclusively over the communications lines previously shared with POTS. This data without POTS (also sometimes referred to as “naked DSL”) continues to work well using the same communications lines previously shared with POTS; however certain issues may arise from the provision of exclusively DSL service over previously shared communications lines that were not present when the POTS signal was also present.

Switched loop services such as POTS use direct current (DC) during off-hook conditions for line signaling. In addition to line signaling, a significant benefit arises from the continued presence of the direct current on the communications line, that is, the DC assists in preventing oxidation of electrical connections or coupling points. Under normal POTS operation, approximately 20 milliamps (mA) of DC will flow through the switched loop during an off-hook condition. This current is used not only to signal the central office (CO) line card but also to help maintain mechanical splices (which are necessary and unavoidable occurrences in communication lines) essentially clean of oxides or high resistance films. The current flow responsible for oxidation avoidance is often referred to as a sealing current.

In the newly emerging environment of data without POTS, absence of the previously concurrently available switched loop signaling DC introduces certain problems. In particular, the absence of switched loop signaling DC in a data without POTS permits mechanical splices to oxidize over a period of time and creates contact problems since the low-level data signals utilized in data without POTS do not carry enough current to properly prevent oxidation.

One positive aspect to the use of VoIP is that such use eliminates the need for Digital Subscriber Line (DSL) splitters in a subscriber premises setting, such as a private residence, apartment building or small business, as well as the need for call signaling and ringing. This positive aspect, however, contributes toward a negative aspect in that without a ringing signal, a sealing current must be supplied. As is well understood by those of ordinary skill in the art, the sealing current previously supplied by way of occasional application of ringing currents must be provided from another source to keep access lines clear of corrosion.

An additional negative aspect to the provision of data without POTS resides in the requirement for a VoIP adapter to be installed at the subscriber premises by trained personnel from the telephone company as subscribers, such as subscribers and small business owners, are not often knowledgeable of proper installation techniques. Not only is such a visit by trained service personnel expensive for the telephone company, but it often involves scheduling between the subscriber and the service provider. Difficulties arising from such required scheduling are well recognized by all parties involved and can be a major source of inconvenience especially to the subscriber who must often take time off from work or other scheduled events to be at the premises for the appointment time.

In view of the above mentioned issues involving installation of data without POTS at a subscriber premises, it would be desirable to have a VoIP electronics package that can easily be installed by the subscriber, thus avoiding dispatch of trained personnel. Subscriber installable equipment could be shipped to the subscriber along with a VoIP modem, thereby completely eliminating the dispatch of trained service personnel, not to mention the significant increase in convenience to the subscriber who may then install the VoIP electronics at a convenient time.

While various data without POTS adapters have been developed, no design has yet emerged that generally encompasses all of the desired characteristics, as hereafter presented in accordance with the present invention.

### SUMMARY OF THE INVENTION

In view of the recognized deficiencies encountered in the prior art and addressed by the present invention, an improved methodology for installing data without POTS electronics at a subscriber premises has been provided.

In an exemplary configuration, a VoIP adapter is provided that enables a subscriber to install necessary line coupling equipment without requiring a service provider to dispatch trained service personnel to the premises.

In a simple form, a data without POTS adapter is provided for mounting in a network interface device, as may commonly be provided at a subscriber premises.

Another positive aspect of this type of adapter is that a subscriber may easily install the VoIP adapter into a network interface device (NID) at the subscriber premises without prior training.

In accordance with aspects of certain embodiments of the present invention, apparatus and methodologies are provided to enable installation of a data without POTS adapter in variously configured NIDs.

In accordance with aspects of other embodiments of the present invention, methodologies are provided to reconfigure existing components in a NID to install a data without POTS adapter.

In accordance with yet additional aspects of further embodiments of the present invention, apparatus and accompanying methodologies have been developed to provide a subscriber with all the components necessary to self-install a data without POTS adapter at a subscriber premises without requiring the intervention or assistance of trained service personnel.

Additional objects and advantages of the present invention are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the disclosure. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present invention may include various combinations or configurations of presently disclosed features, steps, or elements, or their equivalents (including combinations of features, parts, or steps or configurations thereof not expressly shown in the figures or stated in the detailed description of such figures). Additional embodiments of the present invention, not necessarily expressed in the summarized section, may include and incorporate various combinations of aspects of features, components, or steps referenced in the summarized objects above, and/or other features, components, or steps as otherwise shown or discussed in this disclosure.

It should also be appreciated that while the description of the present invention is directed more specifically to installation of VoIP electronics by a subscriber, such is not a requirement. As will be evident to those of ordinary skill in the art, the presently disclosed apparatus and methodologies may also be used and applied by other than subscribers, including service personnel that may have less training than those that might otherwise be dispatched in order to properly install data without POTS electronics.

It should further be appreciated that while the present disclosure is directed to the installation of data without POTS electronics at a subscriber premises, such is also not a limitation of the presently disclosed invention as such equipment may also be installed at locations other than subscriber premises including, for example, larger businesses, office buildings, etc. Those of ordinary skill in the art will better appreciate the features and aspects of such embodiments, and others, upon review of the remainder of this disclosure.

### BRIEF DESCRIPTION OF THE DRAWINGS

A full and enabling disclosure of the present invention, including the best mode thereof, directed to one of ordinary skill in the art, is set forth in this disclosure, which makes reference to the appended figures, in which:

FIG. 1(a) illustrates a data without POTS adapter kit in accordance with a first embodiment of the present invention;

FIG. 1(b) schematically illustrates the relationship among the connector plug, jack, mounting support and VoIP electronics associated with the first embodiment of the present invention, and also illustrates a portion of a modification of the first embodiment of the present invention;

FIGS. 2(a) and 2(b) illustrate exemplary steps for installing a data without POTS adapter in accordance with the present invention into a subscriber premises network interface device (NID); and

FIG. 3 illustrates an alternate embodiment of the present invention for use with insulation displacement connector (IDC) equipped NIDs.

Repeat use of reference characters throughout this written disclosure and the appended drawings is intended to represent the same or analogous features or elements of the invention.

### DETAILED DESCRIPTION OF THE PREFERRED EMBODIMENTS

As previously discussed, the present invention is particularly concerned with apparatus and methodologies for allowing a subscriber to install data without POTS at a subscriber premises without assistance from trained service personnel.

Selected combinations of aspects of the present invention correspond to a plurality of different preferred embodiments. It should be noted that each of the exemplary embodiments presented and discussed herein should not insinuate limitations of the present invention. Features or steps illustrated or described as part of one embodiment may be used in combination with aspects of another embodiment to yield still further embodiments. Additionally, certain features may be interchanged with similar devices or features not expressly mentioned which perform the same or similar function.

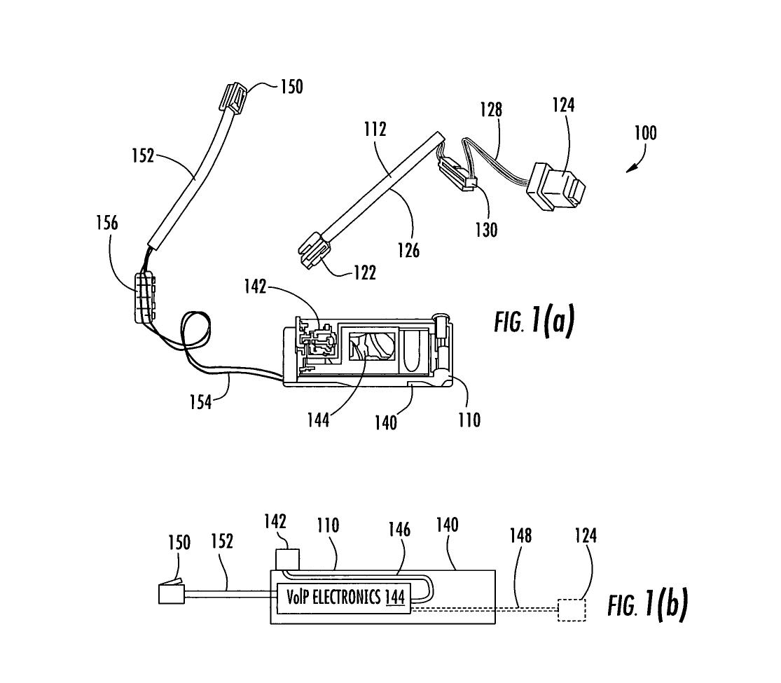

Reference will now be made in detail to the presently preferred embodiments of a data without POTS adapter according to the present invention. Referring now to the drawings, FIG. 1(a) illustrates a data without POTS adapter kit 100 as might be provided to a subscriber as a part of a kit for self-installation of data without POTS at a subscriber premises. The adapter kit 100 includes an adapter 110 and a jumper 112 that may, in fact, be optional for some installations.

Jumper 112 may be described as somewhat similar in function to a common telecommunications patch cord in that jumper 112 corresponds to a multi-wire cable 126 having at least a pair of wires contained therein. The wires contained within cable 126 are coupled to a connector plug 122 attached to one end of the cable. Connector plug 122 is selected to be compatible with any existing line module termination device typically utilized in a NID. A connector jack 124 electrically coupled to at least a pair of wires 128 (e.g., a twisted pair) at one end thereof is coupled at the other end thereof to a connector 130 that is also electrically coupled to the at least one pair of wires contained within cable 126. In this manner, a signal extension cable with matching connector plug and jack is provided for use as required for certain embodiments of the present invention.

In an exemplary configuration, plug 122 and jack 124 may be RJ-11 type devices although, as will be understood by those of ordinary skill in the art, other matching connector plug and jack types may be used. Generally, of course, the plug and jack will be compatible with, although not necessarily identical to, corresponding connector types already installed in the NID.

With further reference to FIG. 1(a), it will be noticed that adapter kit 100 also includes a VoIP adapter 110 that, in an exemplary embodiment, is configured as a snap-in support structure 140 designed to snap in place within an existing network interface device (NID) enclosure as will be more fully described later. VoIP adapter 110 includes support structure 140 on which is mounted an electronics circuit, and in particular, selected VoIP electronics 144. On an upper surface of support structure 140 is mounted a jack 142 that is compatible with plug 122 and is connected electrically to the internally mounted VoIP electronics 144.

VoIP electronics 144 may itself be mounted on a printed circuit board with the printed circuit board mounted to or within the VoIP adapter 110. The VoIP electronics 144 may vary depending on service provider and/or user requirements, but generally the VoIP electronics 144 may include, but is not limited to, sealing current termination circuitry and/or DSL related filters.

With reference to FIG. 1(b), the general relationship of the VoIP adapter 110 with respect to the VoIP electronics 144 is illustrated. Reference numerals appearing in FIG. 1(b) correspond to the same elements appearing in FIG. 1(a) so that there is illustrated a plug 150 electrically coupled to a cable 152 and from there to VoIP electronics 144. Wiring 146 internal to support structure 140 provides a signal connection from VoIP electronics 144 to jack 142 mounted on or incorporated into the upper surface of the support structure.

With further reference to FIG. 1(b), a first modification of the VoIP adapter 110 may be seen by way of reference to the right hand end of support structure 140. As schematically represented and depicted by dashed lines, optional connection lines 148 may be connected directly to VoIP electronics 144 at one end and to a jack 124 at the other end. Connection lines 148 may be chosen to be of such a length as to correspond to at least the combined length of the connecting wires illustrated for jumper 112 in FIG. 1(a). As will be more fully described later, in some embodiments where the use of jumper 112 is required, the alternate form illustrated in FIG. 1(b) may be employed. Such alternate form provides economies of construction by requiring one less plug 122 (compare FIG. 1(a)). In embodiments where jumper 112 is not required, connection lines 148 may be cut to remove the unnecessary components.

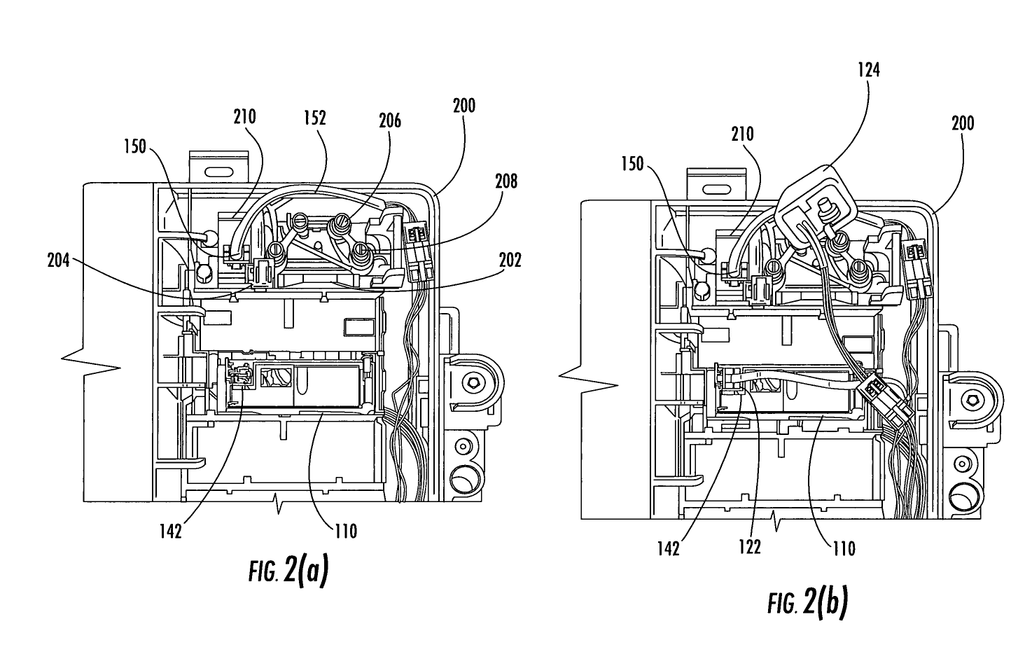

With reference now to FIGS. 2(a) and 2(b), there is illustrated exemplary steps for installing a data without POTS adapter in accordance with the present invention in a subscriber network interface device. As may be observed from FIGS. 2(a) and 2(b), in a first embodiment of the present invention, a subscriber NID 200 may normally be provided in a POTS environment with a conventional line module 202 having screw terminals representatively illustrated at 206, 208.

As a first step in an exemplary self-installation procedure, a subscriber, after gaining access to the interior of the NID by opening a customer access door (not illustrated) will snap VoIP adapter 110 into position within an empty line module slot, as illustrated in FIG. 2(a). The subscriber will then unplug plug 204 from its normally engaged position in jack 210 of existing line module 202 and insert plug 150 of the VoIP adapter 110 into jack 210 of the existing line module.

The plug 204 associated with existing line module 202 is then inserted into jack 124 provided on the optional jumper 112 and the installation is completed by inserting plug 122 of the optional jumper into jack 142 on the upper surface of VoIP adapter 110.

In the instance that optional connection lines 148 and plug 124 are provided as illustrated in FIG. 1(b), the installation sequence of the previous paragraph may be replaced by simply inserting plug 204 associated with existing line module 202 directly into jack 124 provided at the end of optional connection lines 148.

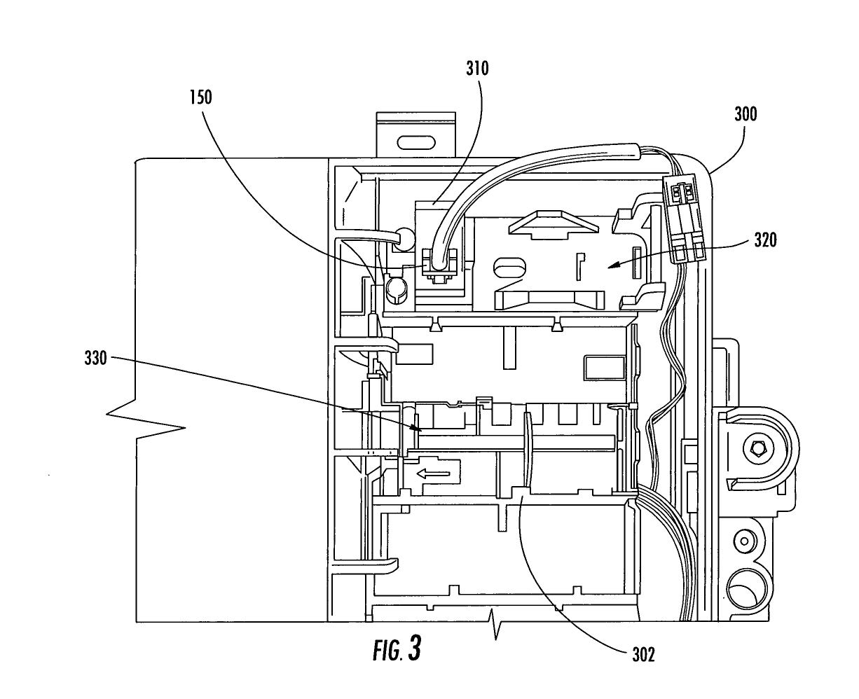

With reference to FIG. 3, there is illustrated a second exemplary embodiment of the present invention for use with insulation displacement connector (IDC) termination device equipped NIDs. In a POTS environment, IDC subscriber bridge 302 equipped with insulation displacement connectors (IDC) is normally positioned in space, or slot, 330 in NID 300. IDC subscriber bridge 302 is normally configured with a plug (not visible) on the underside of the movable cover of the bridge positioned such that, in POTS environments, the plug is compatible with and plugged into a line module jack 310.

In accordance with this second exemplary embodiment of the present invention, installation of VoIP adapter 110 is accomplished by a subscriber by first snapping VoIP adapter 110 into an appropriately configured mounting area 330 of NID 300, for example below IDC subscriber bridge 302. The subscriber will then unplug the subscriber bridge plug from its normal position in area 320 of NID 300 and instead insert it into jack 142 of previously mounted VoIP adapter 110. [Note: VoIP adapter 10 is not shown in FIG. 3] The installation is then completed by inserting VoIP adapter plug 150 into line module jack 310. In this exemplary installation procedure, the optional jumper 112 illustrated in FIG. 1(a) is not required. Moreover, should the VoIP adapter 110 kit be configured as illustrated in FIG. 1(b) to include optional connection lines 148 and plug 124, the connection lines may be cut to remove the plug 124 which, like the optional jumper 112, is not used in this installation configuration. [Note: Is this description of FIG. 3 correct?]

While the present invention has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and does not preclude inclusion of such modifications, variations, equivalents and/or additions to the present invention as would be readily apparent to one of ordinary skill in the art.

That which is claimed is:

1. A DSL adapter comprising:
a support structure configured for snap-in mounting by a subscriber into a network interface device (NID);
an electronics circuit associated with said support structure;
an input plug electrically coupled to an input of said electronics circuit, the input plug being compatibly configured to mate with an existing jack provided in the NID; and
a first output jack electrically coupled to an output of said electronics circuit, the first output jack being compatible with an existing plug provided in the NID;
whereby the subscriber is able to self-install the adapter.

2. An adapter as in claim 1, wherein said output jack is mounted to an upper surface of said support structure.

3. An adapter as in claim 1, further comprising a length of at least two electrically conducting connection lines extending from said support structure and electrically coupled at a first end to said electronics circuit and at a second end to a second output jack, wherein said second output jack is remote from said support structure.

4. A subscriber installable DSL adapter kit comprising:
a support structure configured for snap-in mounting in a network interface device (NID);
an electronics circuit operably associated with said support structure;
an input plug electrically coupled to an input of said electronics circuit, the input plug being compatibly configured to mate with an existing jack provided in the NID;
a first output jack electrically coupled to an output of said electronics circuit, the first output jack being compatible with an existing plug provided in the NID; and
a signal extension cable comprising a predetermined length of at least two electrical conductors and having a plug coupled to a first end thereof and a jack coupled to a second end thereof;
wherein the plug and jack are compatible with each other and with an existing jack provided in the NID; and
whereby a subscriber is provided with a plurality of VoIP self-installation options so that a service provider need not dispatch trained service personnel to the subscriber premises to install the VoIP adapter.

5. A kit as in claim 4, wherein said first output jack is mounted to an upper surface of said support structure.

6. A kit as in claim 4, further comprising a predetermined length of at least two electrically conductive connection lines extending from said support structure and electrically coupled at a first end to said electronics circuit and at a second end to a second output jack, wherein said second output jack is remote from said support structure.

7. A method for installation of a voice over internet protocol (VoIP) adapter in a network interface device (NID), comprising:
providing a VoIP adapter, the adapter comprising a support structure, an input plug, and a first output jack;
mounting the VoIP adapter into a vacant slot in a network interface device (NID);
unplugging an existing plug from an existing jack provided in the NID;
inserting the input plug of the adapter into the existing jack in the NID; and
inserting the existing plug into the first output jack of the adapter.

8. The method of claim 7, further comprising:
providing a signal extension cable comprising a compatible plug and jack electrically coupled together by a cable of a predetermined length;
removing the existing plug from the first output jack of the adapter and connecting the existing plug to the jack of the extension cable; and
connecting the plug of the extension cable to the first output jack of the adapter.

9. The method of claim 7, wherein providing a VoIP adapter comprises providing a VoIP adapter to a subscriber wherein the adapter further comprises a second output jack remote from the support structure and electrically coupled thereto by a length of at least two connection lines.

10. The method of claim 9, further comprising:
removing the existing plug from the first output jack of the adapter and connecting the existing plug to the second output jack.

11. A method for installation of a voice over internet protocol (VoIP) adapter in a network interface device (NID), comprising:
providing a VoIP adapter, the adapter comprising a support structure, an input plug, and a first output jack mounted to an upper surface of the support structure;
mounting the VoIP adapter into a vacant mounting slot in the NID;
coupling a plug of an existing line module to the first output jack of the adapter; and
inserting the input plug of the adapter into a jack of the existing line module in the NID;
whereby a subscriber may provide self-installation of the adapter.
